(19) United States
(12) Patent Application Publication
(10) Pub. No.: US 2013/0300981 A1
(43) Pub. Date: Nov. 14, 2013

(54) PLANAR LIGHT SOURCE APPARATUS AND DISPLAY APPARATUS EQUIPPED WITH THE SAME

(71) Applicant: MITSUBISHI ELECTRIC CORPORATION, Tokyo (JP)

(72) Inventor: Seiji SAKAI, Tokyo (JP)

(73) Assignee: MITSUBISHI ELECTRIC CORPORATION, Tokyo (JP)

(21) Appl. No.: 13/875,947

(22) Filed: May 2, 2013

(30) Foreign Application Priority Data
May 14, 2012 (JP) 2012-110388

(51) Int. Cl. F21V 8/00

(52) U.S. Cl. CPC G02B 6/0011; G02B 6/0033
USPC 349/65

(57) ABSTRACT

A planar light source apparatus includes a light guide plate, an LED arranged on a side surface of the light guide plate, and a functional liquid crystal film. The functional liquid crystal film is provided in a non-light-emitting surface of the light guide plate which is opposite to a light-emitting surface of the light guide plate, and is divided into a plurality of block region. Each of the block regions is individually controllable. Specifically, reflection and transmission of the functional liquid crystal film in each of the block regions are controlled according to an electrical signal, such as voltage.

### BACKGROUND OF THE INVENTION

The present invention relates to a planar light source apparatus including a light source and a light guide plate, and a display apparatus, such as a liquid crystal display apparatus, equipped with the planar light source apparatus.

### DESCRIPTION OF THE BACKGROUND ART

A display apparatus using a display device such as a liquid crystal panel is generally provided with a planar light source apparatus which irradiates a back surface of the display device. In the related art, in such a display apparatus, since light is emitted from the planar light source apparatus for not only a bright display screen but also a dark display screen, power saving is difficult to be achieved. Moreover, when a dark image is displayed, light of the planar light source apparatus leaks, resulting in low contrast. Furthermore, when a moving image is displayed, there is a problem that so-called moving image blur, the phenomenon in which an image appears to drag its tail behind it, occurs.

In order to solve such a problem, proposed is a technology (so-called local dimming) of causing the planar light source apparatus to partially turn on in synchronism with data writing to pixels in the display device. According to this technology, since irradiation of excessive light which is more than needed is suppressed, power consumption can be reduced.

For example, Japanese Patent Application Laid-Open Nos. 2011-009208 and 2011-076999 disclose planar light source apparatuses which perform such local dimming The planar light source apparatus disclosed in Japanese Patent Application Laid-Open No. 2011-009208 includes a light guide plate. In the planar light source apparatus, the light guide plate is divided into a plurality of light guide blocks, and a light amount emitted from an LED light source corresponding to a light guide block is adjusted. In this way, luminance is adjusted for every light guide block.

The planar light source apparatus disclosed in Japanese Patent Application Laid-Open No. 2011-076999 includes a light guide plate, a plurality of light sources, and a control unit which selectively turns on the plurality of light sources. In the planar light source apparatus, the light guide plate is divided into a plurality of blocks, and each block is provided with a reflective surface which reflects only light emitted from a corresponding light source.

However, according to the technology disclosed in Japanese Patent Application Laid-Open No. 2011-009208, the light guide plate can be divided into only 1 vertical line×n horizontal lines, or into 2 vertical lines×n horizontal lines at most. That is, since it is difficult to increase the number of vertical lines, fine control is difficult to be achieved.

On the other hand, according to Japanese Patent Application Laid-Open No. 2011-076999, since the block control can be carried out for every matrix, fine control of luminance is possible. However, since the light guide plate and the light source need to be provided for every block, the number of parts increases. This results in a complicated structure and hence incurs an increased cost. Furthermore, since this technology requires the LED to be arranged under a display region, improvement of display quality is difficult.

### SUMMARY OF THE INVENTION

The present invention has been made in view of the above problems, and an object of the present invention is to provide a technology which can achieve fine local dimming control using a simple structure.

The present invention is a planar light source apparatus including a light guide plate, a light source arranged on a side surface of the light guide plate, and functional liquid crystal films which are provided on a non-light-emitting surface opposite to a light-emitting surface of the light guide plate and divided into a plurality of regions which are individually controllable.

Since each region of the functional liquid crystal film can be individually controlled, the fine local dimming control is achievable. Since the present invention is easily applicable to the configuration of a typical planar light source apparatus, the above-mentioned effect can be achieved using a simple structure.

These and other objects, features, aspects, and advantages of the present invention will become more apparent from the following detailed description of the present invention when taken in conjunction with the accompanying drawings.

### BRIEF DESCRIPTION OF THE DRAWINGS

FIG. 1 is an exploded perspective view illustrating the schematic structure of a liquid crystal display apparatus according to a first preferred embodiment;

FIG. 2 is an exploded perspective view illustrating the schematic structure of a planar light source apparatus according to the first preferred embodiment;

FIG. 3 is a cross-sectional view illustrating the structure of the planar light source apparatus according to the first preferred embodiment;

FIG. 4 is a plan view illustrating the structure of the planar light source apparatus according to the first preferred embodiment, viewed from a non-light-emitting surface side of a light guide plate;

FIG. 5 is a cross-sectional view illustrating an operation of the planar light source apparatus according to the first preferred embodiment;

FIG. 6 is a plan view illustrating the structure of a planar light source apparatus according to a second preferred embodiment, viewed from a light emitting surface side of a light guide plate; and

FIG. 7 is a cross-sectional view illustrating the structure of the planar light source apparatus according to the second preferred embodiment.

### DESCRIPTION OF THE PREFERRED EMBODIMENTS

### First Preferred Embodiment

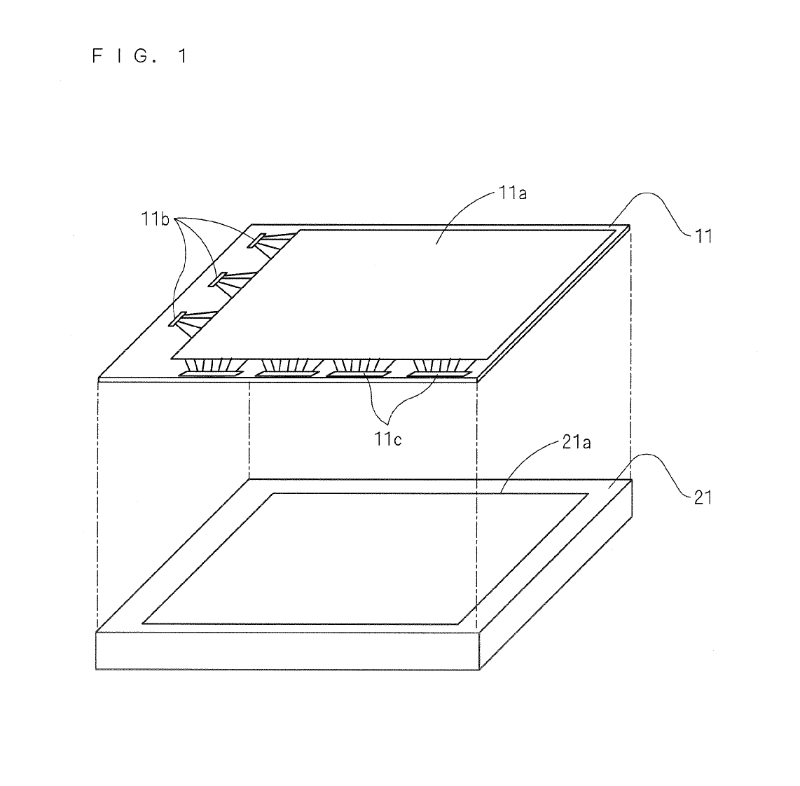

FIG. 1 is an exploded perspective view illustrating an example of the schematic structure of a liquid crystal display apparatus 1 as an example of a display apparatus according to a first preferred embodiment of the present invention. The liquid crystal display apparatus 1 illustrated in FIG. 1 includes a liquid crystal panel 11 which performs data writing to pixels, and a planar light source apparatus 21 which irradiates a back surface of the liquid crystal panel 11 in synchronism with the data writing operation. As described below, the liquid crystal display 1 according to the present embodiment is excellent in the display characteristics of a moving image, and is used for a thin liquid crystal display having a narrowed frame area.

The liquid crystal panel 11 is a transmission-type display device including a TFT (Thin Film Transistor) array substrate and a substrate opposing thereto, between which liquid crystal is held. Multiple TFTs and pixels are arranged in a matrix form in a display region 11a formed on a surface of the liquid crystal panel 11. Here, the display region 11a has a rectangular shape which is horizontally long. In the display region 11 on the TFT array substrate, gate lines (also called address lines) are formed in parallel with the longer side, and source lines (also called data lines) are formed in parallel with the shorter side.

A plurality of gate line-drive drivers 11b causing the TFTs, each serving as a semiconductor switching device provided for every pixel, to turn on or off, and a plurality of source line-drive drivers 11c supplying image data to each pixel via the corresponding TFTs, are formed around the display region 11a. These drivers are formed on the TFT array substrate, each of which is provided in the form of a semiconductor chip, for example, and perform data writing to each pixel by control of a controller. The data writing to each pixel is performed based on a video signal (image signal), and, specifically, image data based on the video signal (image signal) is written in the pixels corresponding to each of the gate lines which are driven to be ON state with a predetermined scanning period.

The planar light source apparatus 21 is a box-shaped apparatus arranged on the back surface side of the liquid crystal panel 11, and emits light to the liquid crystal panel 11 through an opening 21a provided in a surface which faces the liquid crystal panel 11. In the planar light source apparatus 21, a light emitting region is essentially divided into a plurality of block regions based on data writing positions for every gate line in the liquid crystal panel 11, and emission of light to the liquid crystal panel 11 is performed for each block region. The shape of the opening 21a is slightly bigger than the shape of the display region, and the opening 21a has a rectangular shape which is horizontally long. The longer side of the rectangular shape is in parallel with the gate line of the liquid crystal panel 11.

<Planar Light Source Apparatus 21>

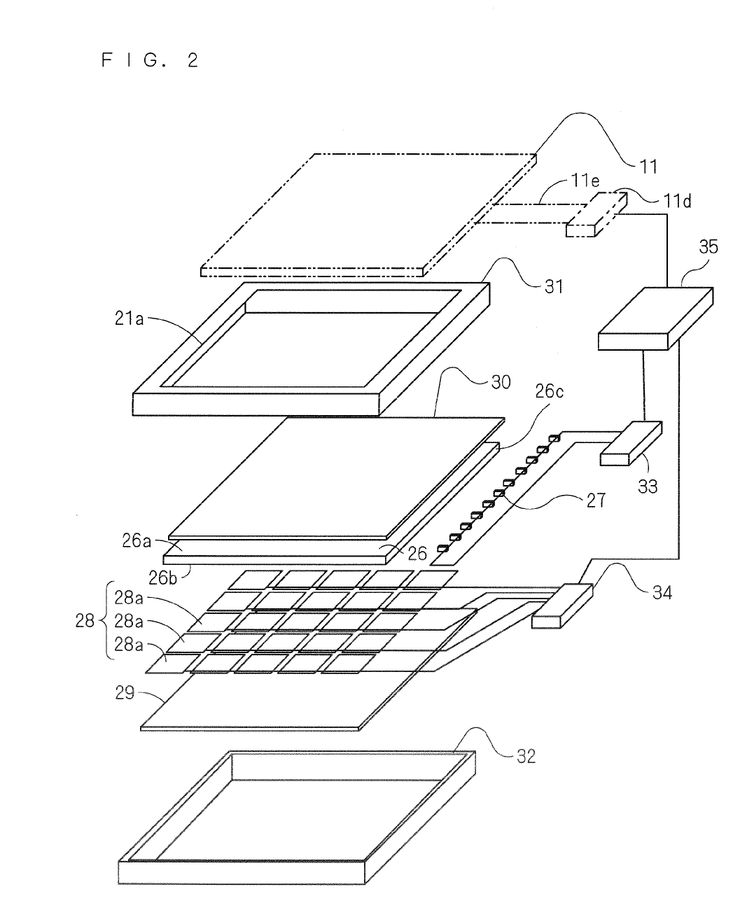

FIG. 2 is an exploded perspective view illustrating an example of the schematic structure of the planar light source apparatus 21 illustrated in FIG. 1. In FIG. 2, the liquid crystal panel 11, a controller 11d described above, and an FPC (Flexible Printed Circuit) 11e which connects these to each other, are illustrated in fictitious outlines (two-dot chain lines) aside from the planar light source apparatus 21. Hereinafter, regarding the planar light source apparatus 21, one side where the liquid crystal panel 11 is provided is referred to as an upper side, and the other side which is opposite to the liquid crystal panel 11 is referred to as a lower side.

The planar light source apparatus 21 illustrated in FIG. 2 includes a light guide plate 26 having a light-emitting surface 26a (upper surface) from which light is emitted to the liquid crystal panel 11, and having a non-light-emitting surface (lower surface) 26b which is opposite to the light-emitting surface 26a, a plurality of LEDs (Light Emitting Diodes) 27 which are a plurality of light sources arranged in an end face (side surface) 26c of one end of the light guide plate 26. And the planar light source apparatus 21 further includes a functional liquid crystal film 28 and a back-surface reflective sheet 29 which are provided on the side of the non-light-emitting surface 26b of the light guide plate 26, a side reflective sheet (not illustrated) provided on the side surfaces other than the end face 26c of the light guide plate 26, an optical sheet 30 provided on the side of the light-emitting surface 26a of the light guide plate 26, and an upper case 31 and a lower case 32 which encase all of these. The liquid crystal panel 11 is arranged on the light-emitting surface 26a of the light guide plate 26.

In addition to the above-mentioned elements, the planar light source apparatus 21 further includes an LED driver 33 which controls the plurality of LEDs 27, a film-drive driver 34 which controls the functional liquid crystal film 28, and a microcomputer 35 which collectively controls the controller 11d, the LED driver 33, and the film-drive driver 34.

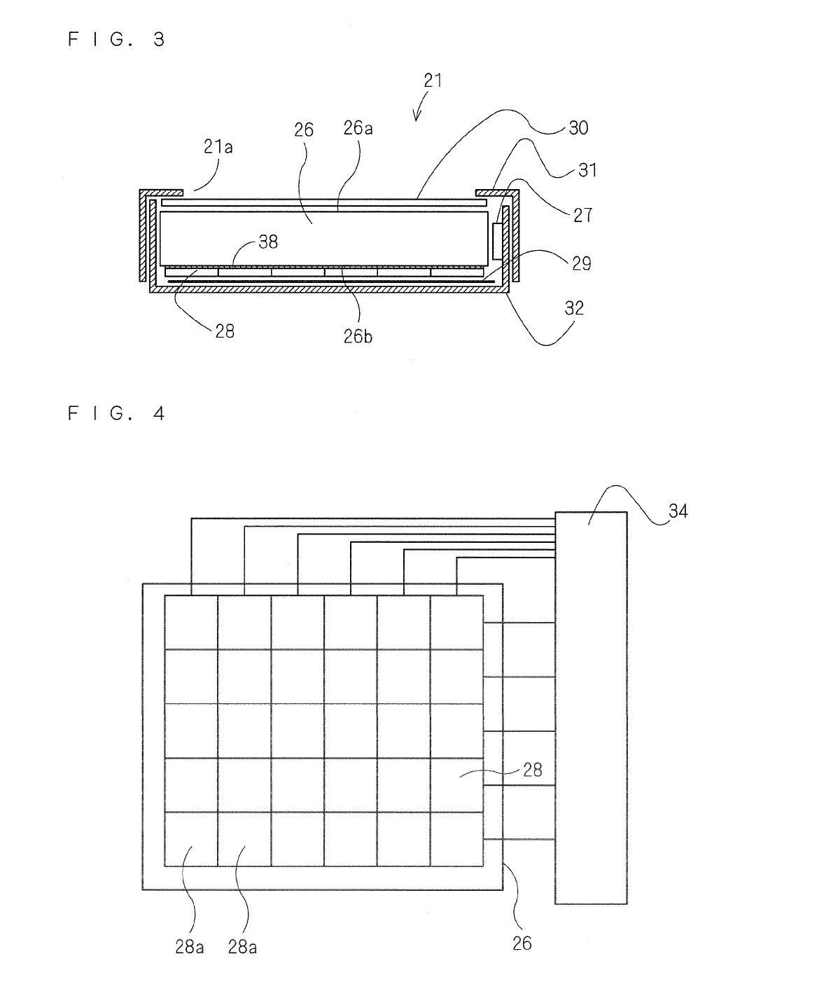

FIG. 3 is a cross-sectional view illustrating an example of the details of the main part of the planar light source apparatus 21 illustrated in FIG. 2. The planar light source apparatus 21 is a side-edge-type planar light source apparatus, and includes the light guide plate 26, the plurality of LEDs 27, the functional liquid crystal film 28, the back-surface reflective sheet 29, the side reflective sheet, the optical sheet 30, the upper and lower cases 31 and 32, and the like. Next, each component of the structure of the planar light source apparatus 21 illustrated in FIGS. 2 and 3 will be described in detail.

<Upper and Lower Cases 31 and 32>

The upper and lower cases 31 and 32 are frames for housing and holding each of the components, and are made of synthetic resin or metal which is excellent in strength and processability. Especially, from a viewpoint of dissipation of heat which is generated due to light emission of the plurality of LEDs 27, it is desirable that the upper and lower cases 31 and 32 are made of aluminum or copper which is excellent in thermal conductivity. The opening 21a through which the light from the light-emitting surface 26a of the light guide plate 26 is emitted to the liquid crystal panel 11, is formed in the upper case 31.

<Light Guide Plate 26>

The plurality of LEDs 27 is arranged in the end face 26c of the light guide plate 26, and the light emitted from each of the LEDs 27 is incident onto the end face 26c. The light guide plate 26 is an optical member which allows the light from the LEDs 27 to propagate inside the light guide plate 26, and then, at the border between the light guide plate 26 and the outside (for example, air), reflects the light so that the light may travel back into the light guide plate 26 or may be emitted from the light guide plate 26. A plate member made of a transparent material, for example glass and organic resin, such as an acrylic resin and a polycarbonate resin, is applied to the light guide plate 26.

<LED 27>

According to the present embodiment, the plurality of LEDs 27 is used as the light sources arranged in the end face 26c of the light guide plate 26. Furthermore, the light source arranged in the end face 26c of the light guide plate 26 is not necessarily limited to the LED 27, but may be a point light source which is formed from a light-emitting element such as an LD (Laser Diode) and an EL (Electro Luminescence) element and which can perform fast switching at several ms or less.

In the present embodiment, the plurality of LEDs 27 is configured by combining multiple colors of LEDs, each emitting light of one color (herein, R (red), G (green), or B (blue)). If the planar light source apparatus 21 is configured in a manner to adjust the light emitting amount for each LED, the color tone of the emitted light can be easily changed. In addition, the color reproducibility in a screen display of the liquid crystal panel 11 can be improved.

In the example of FIG. 3, the plurality of LEDs 27 is attached to a curved portion which faces the end face 26c of the light guide plate 26, of the lower case. However, the attachment form of the plurality of LEDs 27 is not necessarily limited to this, and the plurality of LEDs 27 may be mounted on a printed circuit board to protrude from the printed circuit board, for example. The plurality of LEDs 27 is connected to the LED driver 33 which drives each of the LEDs 27 as illustrated in FIG. 2.

<LED Driver 33>

By the control (command) of the microcomputer 35, the LED driver 33 controls a total light amount emitted from the plurality of LEDs 27 to the end face 26c of the light guide plate 26, based on a total luminance for one screen of a video signal which drives the liquid crystal panel 11, as described in detail below. In the present embodiment, a drive control unit (not illustrated) in the LED driver 33 controls (or adjusts) the total light amount by increasing or decreasing current, voltage, and duty ratio based on the control of the microcomputer 35. Regarding the LED driver 33, when a light source system driving the plurality of LEDs 27 is divided into sub-systems, the light amount emitted from the plurality of LEDs 27 may vary from sub-system to sub-system.

<Functional Liquid Crystal Film 28>

The functional liquid crystal film 28 is provided on the non-light-emitting surface 26b of the light guide plate 26. Here, as an example of such a configuration, the functional liquid crystal film 28 is attached to the non-light-emitting surface 26b of the light guide plate 26 without gap, by a double-sided tape 38 which is high in transparency. The functional liquid crystal film 28 is divided to form a matrix, more specifically, into a total of 25 block regions 28a (a plurality of regions) in which 5 lines are arranged in the transverse direction and 5 lines are arranged in the longitudinal direction.

The functional liquid crystal film 28 includes a pair of transparent plastic substrates on which transparent electrodes made of transparent metal such as iridium tin oxidation (ITO) are formed, and a liquid crystal layer which is made of a composite material (a polymer and liquid crystal molecules) and which is inserted between the substrates. In the liquid crystal layer, the polymer is formed in the shape of a network (in a mesh shape), and the liquid crystal molecules are provided in spaces between the meshes of the polymer with the orientations of the liquid crystal molecules in an irregular state.

The transparent electrode is provided for every block region 28a, and a predetermined voltage of a predetermined frequency (an AC signal frequency) can be individually applied to each of the transparent electrodes of the block regions 28a.

In the block region 28a where the voltage is not applied to the transparent electrode, the orientations of the liquid crystal molecules are irregular, and the liquid crystal molecules diffuse-reflect a portion of incident light. Namely, the functional liquid crystal film 28 in the block region 28a where the voltage is not applied to the transparent electrode, will go into a cloudy state in which it shines in an opalescent color as a result of the partial diffuse reflection of the incident light. In this block region 28a, the remaining light which is not diffuse-reflected by the liquid crystal molecules transmits through the functional liquid crystal film 28.

On the other hand, in the block region 28a where the voltage is applied to the transparent electrode, the orientations of the liquid crystal molecules are aligned in perpendicular to the transparent electrode, and as a result, the incidence light will be rarely diffuse-reflected. Namely, the functional liquid crystal film 28 in the block region 28a where the voltage is applied to the transparent electrode, will go into a transparent state in which the functional liquid crystal film 28 allows transmission of almost all of the incidence light.

Further, in the functional liquid crystal film 28 in each block region 28a, the reflection (reflectance) and the transmission (transmissivity) of the diffuse reflection are individually controlled according to an electrical signal such as voltage.

FIG. 4 is a plan view of the light guide plate 26 and the functional liquid crystal film 28, viewed from the side of the non-light-emitting surface 26b of the light guide plate 26. As illustrated in FIG. 4, the functional liquid crystal film 28 is provided on the non-light-emitting surface 26b of the light guide plate 26, and the block regions 28a are arranged in a matrix form (multiple lines in each of the transverse direction and the longitudinal direction). However, the block regions 28a may be arranged in the form of multiple lines in both of the transverse direction and the longitudinal direction, or may be, for example, arranged in the form of multiple lines only in the transverse direction or the longitudinal direction.

If only the viewpoint of suppressing the reflection of unnecessary light between the light guide plate 26 and the functional liquid crystal film 28 is taken into consideration, the contact between the light guide plate 26 and the double-sided tape 38, and the contact between the double-sided tape 38 and the functional liquid crystal film 28 are made tight so that an air layer may not be formed in the contact portions. From a viewpoint of suppressing luminance irregularity in the display region, it is preferable that the gap between the adjacent block regions 28a is made as small as possible.

The block region 28a illustrated in FIG. 4 is electrically connected to the film-drive driver 34 via wiring, for example, like in the liquid crystal panel 11. Furthermore, the reflectance and transmissivity of the functional liquid crystal film 28 in each of the block regions 28a are individually controlled according to the electrical signal (voltage, etc.) which is input via the wiring from the film drive driver 34.

<Film-Drive Driver 34>

The film-drive driver 34 which is a drive driver (control unit) of the functional liquid crystal film 28 controls the electrical signal (for example, voltage, current, duty ratio, or the like), which is applied to the functional liquid crystal film 28 in each of the block regions 28a, by control (command) of the required light amount supplied from the microcomputer 35. That is, the film-drive driver 34 individually controls (or adjusts) the reflectance and transmissivity of the functional liquid crystal film 28 in each of the block regions 28a.

<Double-Sided Tape 38>

As described above, the double-sided tape 38 having a high transmissivity is provided between the light guide plate 26 and the functional liquid crystal film 28. The double-sided tape 38 is a tape exhibiting a high transmisivity with respect to all light beams, such as a low-haze tape. A tape with a refractive index which equals to or approximates that of acrylics or glass is used for the double-sided tape 38. According to the configuration using such a double-sided tape 38, it is possible to suppress luminance deterioration or reflection in the interface with the light guide plate 26, and in the interface with the functional liquid crystal film 28. An acrylic adhesive material is used for an adhesive material of the double-sided tape 38, for example. Although the configuration of the planar light source apparatus 21 using the double-sided tape 38 has been described hereinabove, the adhesive material is not limited thereto. That is, for example, an adhesive material having a transmissivity may be used instead of the double-sided tape 38.

<Side Reflective Sheet>

The side reflective sheet is arranged on side surfaces of the light guide plate 26, except for the end face 26c of the light guide plate 26. The side reflection sheet reflects the light emitted from those side surfaces toward the light guide plate 26. A sheet-like optical member made of a silver-deposited plate or a white resin board is used as the side reflective sheet, for example. In terms of effective reflection of the light emitted from the LEDs 27, it is preferable that the reflectance of the side reflective sheet is 90% or more.

<Back-surface Reflective Sheet 29>

The back-surface reflective sheet 29 (reflective sheet) is arranged on a side opposite to the light guide plate 26 regarding to the functional liquid crystal film 28 (under the functional liquid crystal film 28). For example, an optical member similar to the side reflective sheet is used as the back-surface reflective sheet 29.

<Optical Sheet 30>

The optical sheet 30 is arranged between the liquid crystal panel 11 and the light guide plate 26. The optical sheet 30 is formed from a sheet-like optical member which has a light transmitting characteristic, such as a diffusion sheet which diffuses light, or a prism sheet in which prism columns are formed. Among these, the diffusion sheet is formed by mixing fine particles of reflective material with a transparent member, such as a synthetic resin and glass, or by roughening the surface of the transparent member. In order to impart desired luminance distribution and chromaticity distribution to the light-emitting surface, the optical sheet is configured by combining different kinds of diffusion sheets, prism sheets, etc. as necessary, or combining multiple sheets of one kind.

<Light Path>

Next, a light path in the planar light source apparatus 21 having the structure described above is described with reference to FIG. 5. The light path is shown by an arrow of a dashed line in FIG. 5. As for the functional liquid crystal film 28, the block region 28a with a high transmissivity to which a voltage is applied is not given hatching, but the block region 28a with a high diffuse reflectance to which a voltage is not applied is given hatching.

The light emitted from the LED 27 is incident onto the end face 26c of the light guide plate 26. Then, the light which has been incident onto the end face 26c propagates through the light guide plate 26, and is then incident onto the functional liquid crystal film 28 through the light-emitting surface 26a or the side surface of the light guide plate 26, or the double-sided tape 38.

The light which is incident onto the light-emitting surface 26a of the light guide plate 26 after propagating is reflected (i.e., totally reflected) from the light-emitting surface 26a. On the other hand, the light, which is incident onto the side surface of the light guide plate 26 after propagating, is emitted to the outside of the light guide plate 26 from the side surface, then reflected from the side reflective sheet, and, after that, enters back into the light guide plate 26. According to the planar light source apparatus 21 provided with the side reflective sheet, the power consumption of the plurality of LEDs 27 can be reduced because the light emitted from the plurality of LEDs 27 can be effectively used.

Next, the light which is incident onto the functional liquid crystal film 28 after propagating is described. In the block region 28a having a high transmittivity to which a voltage or the like is applied, the light which is incident via the light guide plate 26 and the double-sided tape 38 from the LEDs 27, transmits through the block region 28a and hence reaches the interface between the air layer and the lower surface of the functional liquid crystal film 28. And the light which has reached the interface, is specular-reflected (for example, totally reflected) at the interface so as to turn back into the functional liquid crystal film 28, and is then incident onto the non-light-emitting surface 26b of the light guide plate 26. Since the light which is incident onto the non-light-emitting surface 26b of the light guide plate 26 from the block region 28a having a high transmissivity, has a large incidence angle with respect to the light-emitting surface 26a, the light is reflected and hence travels back into the light-emitting surface 26a (i.e., the light is totally reflected).

Therefore, the light which is incident onto the light-emitting surface 26a or the side surface of the light guide plate 26, or onto the block region 28a having a high transmissivity, continues to propagate again inside the light guide plate 26. In this way, since the light emitted from the plurality of LEDs 27 can be effectively used, the power consumption of the plurality of LEDs 27 can be reduced.

On the other hand, in the block region 28a having a high diffuse reflectance to which a voltage or the like is not applied, the light which is incident via the light guide plate 26 and the double-sided tape 38 from the LEDs 27 is diffuse-reflected. A part of the light which is diffuse-reflected from the functional liquid crystal film 28 is incident onto the light-emitting surface 26b of the light guide plate 26. Since the light which is incident onto the non-light-emitting surface 26b of the light guide plate 26 from the block region 28a having a high diffuse reflectance, has a small incidence angle with respect to the light-emitting surface 26a, the light is emitted to the outside of the light-emitting surface 26a of the light guide plate 26, and is then incident onto the liquid crystal panel 11.

According to the planar light source apparatus 21 and the liquid crystal display apparatus 1 according to the present embodiment, structured in the way described above, fine local dimming control is achievable because the functional liquid crystal films 28 can be individually controllable in every block region 28a. The configuration according to the present embodiment is achievable by using one light guide plate 26, and the configuration is almost the same as usual planar light source apparatuses except providing the functional liquid crystal films 28 in the light guide plate 26. Accordingly, the above-mentioned effects can be achieved using a simplified structure. Furthermore, an increase in the number of parts required to achieve the local dimming control, and the cost can be suppressed. When one light source is used instead of using the plurality of LEDs 27, the increase in the number of parts, and cost can be more certainly suppressed.

In addition, according to the present embodiment, reflection and transmission of the functional liquid crystal film 28 in each of the block regions 28a are controlled according to an electrical signal, such as voltage. Therefore, as described below, moving image blur can be suppressed as well as contrast and display quality can be improved.

In addition, according to the above-described configuration, a portion of the diffuse-reflected light in the block region 28a having a high diffuse reflectance is incident onto the non-light-emitting surface 26b of the light guide plate 26 as described above, but the remaining light transmits through the functional liquid crystal film 28 and is then emitted downward. Here, in the present embodiment, the back-surface reflective sheet 29 is provided there, and the back-surface reflective sheet 29 reflects the light emitted downward from the functional liquid crystal film 28, toward the light guide plate 26 and the functional liquid crystal film 28. In this way, since the light emitted from the plurality of LEDs 27 can be effectively used, the power consumption of the plurality of LEDs 27 can be reduced.

<Control of Functional Liquid Crystal Film 28 and Liquid Crystal Panel 11>

Regarding control of the functional liquid crystal film 28 and the liquid crystal panel 11, control of the functional liquid crystal film 28 is described first. According to the present embodiment, the microcomputer 35 performs analysis on the block region which should brighten up the liquid crystal panel 11 and the block region which should darken up the liquid crystal panel 11, based on the video signal (video information) used in the liquid crystal panel 11. Then, the microcomputer 35 controls the electrical signal which is input to the functional liquid crystal film 28 in each of the block regions 28a, by controlling the film drive driver 34 based on the analysis result.

According to the planar light source apparatus 21 and the liquid crystal display apparatus 1 of the present embodiment, structured in the way described above, for example, when dark video is displayed in the display region, the light which is emitted from the planar light source apparatus 21 can be reduced by lowering the diffuse reflectance of the functional liquid crystal film 28 (or by raising the transmissivity). Accordingly, the light leaking from the liquid crystal panel 11 can be reduced. Therefore, the contrast may be improved and hence the display quality may be improved. In addition, when the video of the liquid crystal panel 11 moves (or changes), the light amount emitted from the planar light source apparatus 21 can be reduced. Then, after finishing the movement (change) of the video of the liquid crystal display panel 11, the light amount emitted from the planar light source apparatus 21 can be increased. Accordingly, the moving image blur can be suppressed.

Next, the control of the liquid crystal panel 11 is described. According to the present embodiment, the microcomputer 35 calculates the total light amount required for a display, based on the total luminance for one screen of the video signal (video information) which drives the liquid crystal panel 11. Next, the microcomputer 35 transmits a required current value based on the calculation result to the LED driver 33, and the LED driver 33 controls the plurality of LEDs 27 with the current specified by the microcomputer 35. That is, the microcomputer 35 controls the total light amount of the plurality of LEDs 27 based on the calculation result.

According to the planar light source apparatus 21 and the liquid crystal display 1 of the present embodiment, structured in the way described above, since only power corresponding to the required light amount can be supplied to the LEDs 27, consumption of the electric power can be suppressed and hence power-saving becomes possible.

### Second Preferred Embodiment

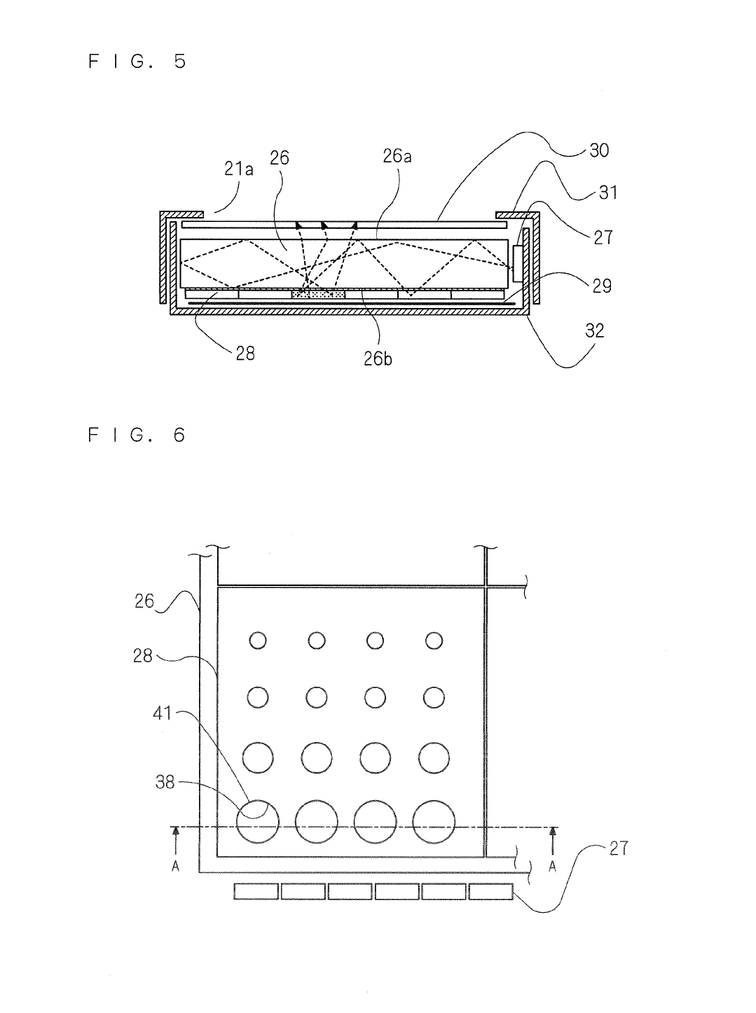

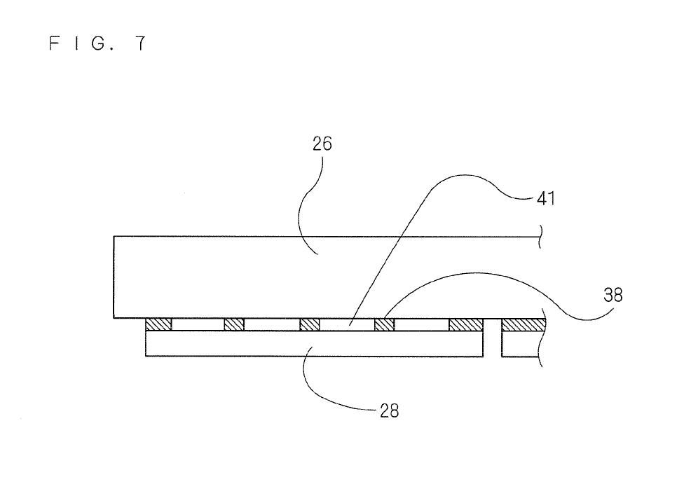

FIG. 6 is a plan view illustrating an example of the structure of a planar light source apparatus 21 according to a second preferred embodiment of the present invention, and FIG. 7 is a cross-sectional view taken along a A-A line illustrated in FIG. 6. In a planar light source apparatus 21 according to the present embodiment, the same components as or equivalent components to the planar light source apparatus 21 described in the first preferred embodiment are denoted by the same reference numerals, and a description will be made while focusing on different points from the first preferred embodiment.

As illustrated in FIGS. 6 and 7, in the present embodiment, a shape of a double-sided tape 38 which bonds a functional liquid crystal film 28 and a light guide plate 26 differs from a shape thereof in the first preferred embodiment. Specifically, the double-sided tape 38 is not provided on all over the functional liquid crystal film 28 and the light guide plate 26, but partially removed. That is, a plurality of air layers 41 is provided between the functional liquid crystal films 28 and the light guide plate 26.

Then, as illustrated in FIG. 6, in each of the block regions 28a of the functional liquid crystal films 28, the diameter (size) of the plurality of air layers 41 is increased as the distance from an LED 27 is decreased, and the diameter (size) of the plurality of air layers 41 is decreased as the distance from the LED 27 is increased. Although the air layers 41 are arranged in a matrix form in FIG. 6, the air layers 41 may be randomly arranged. Furthermore, the shape of each air layer 41 is not limited to a circular form.

Next, an operation of the planar light source apparatus 21 according to the present embodiment, structured in the way described above, is explained. Here, voltage or the like is not applied to a block region 28a which is an observation target, and the block region has a high diffuse reflectance.

Light from the LED 27 (light from the light guide plate 26) which is incident on the block region 28a, enters into the block region 28a, through the double-sided tape 38 at a location where the air layer 41 is not formed, like in the first preferred embodiment. As a result, a portion of the light is diffuse-reflected and then the portion is emitted from a light-emitting surface 26a. On the other hand, at a location where the air layer 41 is formed, the light from the LED 27 is specular-reflected from a non-light-emitting surface 26b of the light guide plate 26, and continues to propagate through the inside of the light guide plate 26. That is, even in the block region 28a where a diffuse reflectance is high, at a location where the air layer 41 is formed, the light is not diffuse-reflected and thus the light which is emitted from the light-emitting surface 26a is suppressed.

Here, in the planar light source apparatus 21 according to the first preferred embodiment, even within one block region 28a, there is a weak tendency that an amount of light emitted toward the liquid crystal panel 11 is increased as the distance from the LED 27 is decreased. Thus, the luminance distribution in one block region 28a is slightly uneven.

On the other hand, in the planar light source apparatus 21 according to the present embodiment, the degree of diffuse reflection can be reduced in a region near the LED 27 of the block region 28a by the provision of the plurality of air layers 41. As a result, the luminance distribution in one block region 28a becomes even, which improves display quality.

Hereinabove, the configuration in which the size of the plurality of air layers 41 is decreased as the distance from the LED 27 is increased has been described. However, the configuration is not limited to the described example. For example, the configuration in which the number of the plurality of air layers 41 per unit area is decreased as the distance from the LED 27 is increased also can eliminate unevenness in the luminance distribution in one block region 28a.

In addition, the following configuration also may be considered. That is, over a plurality of block regions 28a (for example, over the entire functional liquid crystal films 28) rather than over each block region 28a, either the size of the plurality of air layers 41 or the number of the air layers 41 per unit area may be decreased as the distance from the LED 27 is increased. According to such a configuration, the evenness in the luminance distribution can be obtained all over the functional liquid crystal films 28. To increase the luminance of a center portion of the planar light source apparatus 21, the configuration in which at least one of the size of the plurality of air layers 41 and the number of the plurality of air layers 14 per unit area are decreased in the center portion may be adopted.

Furthermore, the configuration in which the double-sided tape 38 partially removed is provided between the functional liquid crystal film 28 and the light guide plate 26 has been described, but the configuration is not limited thereto. For example, the configuration may be obtained by selectively forming an adhesive portion and a non-adhesive portion by using silk printing of a transparent adhesive material. When this configuration is adopted, the adhesive portion and the non-adhesive portion correspond to the double-sided tape 38 and the air layers 41. In this case, since the adhesive portions and the non-adhesive portions can be, generally, precisely and finely controlled, the luminance distribution over a screen can be adjusted with high precision and thus display quality can be improved.

Each of the embodiments can be combined freely within the scope of the present invention, so that each of the embodiments can be suitably changed, altered, or removed.

While the invention has been shown and described in detail, the foregoing description is in all aspects illustrative and not restrictive. It is therefore understood that numerous modifications and variations can be devised without departing from the scope of the invention.

What is claimed is:

1. A planar light source apparatus comprising:
a light guide plate;
a light source arranged on a side surface of said light guide plate; and
a functional liquid crystal film provided on a non-light-emitting surface opposite to a light-emitting surface of said light guide plate and divided into a plurality of regions, said functional liquid crystal film in each of said regions being individually controllable.

2. The planar light source apparatus according to claim 1,
wherein reflection and transmission of said functional liquid crystal film in each of said regions are individually controlled according to an electrical signal.

3. The planar light source apparatus according to claim 1,
wherein said plurality of regions of said functional liquid crystal film includes a plurality of block regions arranged in at least one direction of a transverse direction and a longitudinal direction.

4. The planar light source apparatus according to claim 2, further comprising:
a control unit which controls said electrical signal which is input to said functional liquid crystal film in each of said block regions.

5. The planar light source apparatus according to claim 1,
wherein a plurality of air layers is provided between said functional liquid crystal film and said light guide plate, and wherein at least one of a size of said plurality of air layers and the number of said plurality of air layers per unit area is decreased as a distance from said light source is increased within each of said regions of said functional liquid crystal film, or within said plurality of regions of said functional liquid crystal film.

6. The planar light source apparatus according to claim 1, further comprising:
a reflective sheet arranged on a side opposite to said light guide plate regarding to said functional liquid crystal film.

7. A display apparatus comprising:
said planar light source apparatus according to claim 1; and
a display device arranged on said light-emitting surface of said light guide plate.

8. The display apparatus according to claim 7,
wherein a light amount emitted from said light source is controlled based on a total luminance for a screen of a video signal which drives said display device.

9. The display apparatus according to claim 7,
wherein an electrical signal which is input to said functional liquid crystal film in each of said regions is controlled, based on a video signal used in said display device.
